(19) United States
(12) Patent Application Publication
(10) Pub. No.: US 2005/0010667 A1
(43) Pub. Date: Jan. 13, 2005

(54) System and method for resource accounting on computer network

(75) Inventors: Toshiomi Moriki, Kunitachi (JP); Keitaro Uehara, Kokubunji (JP); Yuji Tsushima, Hachioji (JP); Tsuyoshi Tanaka, Kokubunji (JP)

Correspondence Address: Stanley P. Fisher;Reed Smith LLP, Suite 1400, 3110 Fairview Park Drive, Falls Church, VA, 22042-4503, US

(73) Assignee: Hitachi., Ltd.

(21) Appl. No.: 10/751,434

(22) Filed: Jan. 6, 2004

(30) Foreign Application Priority Data
Jul. 8, 2003 (JP) 2003-193335

(51) Int. Cl. G06F 15/173

(52) U.S. Cl. 709/226; 709/223

(57) ABSTRACT

A sever includes an SVP 206 which is a control device capable of executing processing independent of a CPU, and an interrupt 314 is periodically applied to the CPU. An SVP device driver 303, being triggered by the interrupt 314, acquires an amount of server resources used, such as CPU operating time and memory capacity, and user information used by using an API provided by an OS, and delivers such information to an SVP 206. The SVP 206 transmits resource information thus delivered to an accounting server via an NIC 211. The accounting server accounts an amount of server resource used on a user basis and bills the users according to the quantity of server resource used. With such arrangement, it is possible to accurately grasp the usage status of server resource regardless of server loading, and further, it is possible to execute accounting of server resources and billing based on such accounting regardless of types of OS or CPU.

### FIELD OF THE INVENTION

The present invention relates to methods for resource accounting on computer network, more specifically to a method for resource accounting that does not cause any load on a server and facilitates introduction to an existing system.

### BACKGROUND OF THE INVENTION

Dissemination of the Internet in recent years has been accelerating information systems in enterprises to be larger and more complicated, which, in turn, has drastically increased the number of servers owned by enterprises, thus increasing server administration costs thereof. A business called the Internet Data Center (IDC) has been widely used as an outsourcing business that operates and manages the servers on behalf of those enterprises. IDC traders operate and manage many servers, let out the servers to many users such as enterprises and organizations, and collect server usage fees by the day or by the month.

A business model called the utility computing has been gathering attention as a style of the IDCs. For the utility computing, an IDC trader collects usage charges in accordance with server resources such as CPU operating time, memory capacity, storage capacity and network band used by a user. In this connection, the utility computing offers an advantage that the user only has to pay an economical fee during a period in which the server is not used frequently. The utility computing performs the accounting according to a user, however, it is necessary to collect server resources used by many servers and accurately grasp accounting by users.

A method for operating software called an agent on the OS of each server has been known as one of prior art methods for grasping the usage status of server resources (hereinafter referred to as the “first prior art”).

With this method, the agent communicates with the OS (Operating System) on a regular basis by means of a system call, etc. to acquire usage status of server resources. Then, the agent reports the usage status of the acquired server resources to an accounting server. The accounting server collects the report according to a user and accounts the user in accordance with the usage status of server resources.

Japanese Patent Laid-open No. 07-129271 has disclosed the “operation recording storage type information processing system” as a second method for grasping the usage status of server resources (hereinafter referred to as the “second prior art”).

With the method, a server is provided with operation status detection means, and the operation status detection means performs pairing and recording of a performance code recorded in a main memory, a start time of CPU operation and an end time of CPU operation. The OS allocates a CPU time to a user process in accordance with the performance code recorded. A billing person executes billing based on information (consisting of a performance code, start time of CPU operation and end time of CPU operation) recorded in the operation status detection means.

Japanese Patent Laid-open No. 06-95924 has disclosed the “performance data collecting system” as a third method for grasping the usage status of server resources (hereinafter referred to as the “third prior art”).

According to the method, the OS is provided with a process timer which is updated while a process in a segment to which billing is instructed by a non-accounting identifier is executed. The OS, at the time of a roll-out, calculates the CPU time to be accounted, by subtracting the time used by the process timer, assuming the time to be non-accounting, from the CPU time to be accounted. A billing person executes billing based on the CPU operating time thus calculated.

Japanese Patent Laid-open No. 2001-222336 has disclosed “a recording medium in which an accounting system, an accounting control circuit, an accounting control method and an accounting control program” as a fourth method for grasping the usage status of server resources (hereinafter referred to as the “fourth prior art”).

With the method, an extension device (e.g. a disk drive or a network apparatus) of a server is provided with an accounting control circuit to measure access frequency or access time from a user. A billing person executes billing based on the access frequency or the access time thus measured.

In the first prior art, an agent operating on the OS of each server acquires usage status of server resources. Consequently, when the server loading increases, server resources such as CPU operating time cannot be allocated to the agent itself. When such situation occurs, there will be a problem that operations of the agent delay, making it impossible to ensure grasping of usage status of server resources at a constant interval, and eventually, a value that does not represent the actual usage status of server resources will be reported. To resolve the problem, a method for executing the agent with the priority higher than the user process may be an alternative choice. In this case, however, the server resources to be consumed at the agent will increase to cause a possibility that sufficient server resources may not be supplied to the user process. Therefore, the method is not considered to be satisfactory.

In this connection, a first problem to be solved is to enable accurate grasping of the usage status of server resources even when the server loading becomes increased.

In the second prior art, it is necessary for the OS and the operation status detection means to read out a performance code that is recorded in the main memory. According to the method, it is mandatory for the OS to establish scheduling of processes in accordance with the performance code, and the method cannot be applied to the OS which does not consider the performance code. In addition, when the operation status detection means is designed to read out the performance code, it is inevitable to designate a physical memory address, but the data arrangement on the physical memory of an OS differs by revisions. Therefore, the method cannot be applied to OS's which are different in revisions.

On the other hand, with the third prior art, it is inevitable to change the process dispatcher of an OS. This means the method cannot be applied to existing OS's. Further, for OS's such as Microsoft Windows®, the method cannot be applied to OS's where acquisition of accounting information by users is not considered in nature.

Therefore, a second problem to be solved is to grasp the usage status of server resources without depending on an OS.

With the fourth prior art, there is a problem that, among server resources, the usage status of CPU operating time cannot be acquired. This is because the prior art aims to arrange an accounting control circuit in a peripheral apparatus. In addition, assuming a case where application of the fourth prior part is sought for by modifying a CPU architecture, significant efforts are needed for tests and migration of software to ensure compatibility with huge software assets of user. Therefore, the method is not practical.

In this connection, a third problem to be solved is to grasp the usage status of server resources including CPU operating time without modifying the CPU architecture.

The present invention has been made to solve the above problems and it is an object of the present invention is to provide a method for resource accounting on a computer network, which can accurately acquire resources even if a server has a large load and which can be introduced to an existent OS or architecture of a CPU without modifying the same.

### SUMMARY OF THE INVENTION

In order to solve the above-described problems, the system for resource accounting on a computer network according to the present invention is configured by connecting several servers with which a user uses resources and an accounting server which accounts server resources that are used in the above-stated servers over a network. The server is configured to include a CPU which operates OS or application software, and a control device which executes processing separately from the CPU.

The server monitors on a user basis an amount of computing resources used by registered users through the accounting server by implementing the OS or application software.

Then, for example, after a given period of time, the computing resource information used by the user is acquired by allowing the control device to apply an interrupt to the device driver of the OS, thus causing the OS to make an API call. Alternatively, the application software running on the OS may acquire the computing resource information used.

The OS or the application software writes the computing resource information used that acquired in the above on the memory, etc. of the control device.

The control device transmits the computing resource information used thus delivered to the accounting server via a network.

In the method, the computing resource information used is acquired by executing communication from a control device independently arranged from the CPU to the OS or application software, and not from an agent which runs on the OS. In general, since the OS processes requests such as an interruption from the hardware as the first priority, it is possible to acquire computing resource information used without any delay, even if the OS is loaded to a higher level. Consequently, with such capability, the first problem can be resolved.

In general, a device driver which receives an interrupt from the hardware can be developed according to an OS. In addition, APIs to acquire the usage status of computing resources from the OS or application software are disclosed to the public. Therefore, the present invention can be applied by developing a device driver compatible to an OS. Consequently, with such capability, the second problem can be resolved.

Further, since the present invention provides a control device which operates independently of the CPU on the server, it is possible to grasp the usage status of computing resources including the CPU operating time of the CPU without modifying the CPU. Consequently, with such capability, the third problem can be resolved.

### BRIEF DESCRIPTION OF THE DRAWINGS

FIG. 1 is a configuration diagram of the entire computer system according to a first embodiment of the present invention;

FIG. 2 is an internal configuration diagram of a server 101a;

FIG. 3 is a diagram showing a configuration of an SVP 206 and communication interface between the SVP 206 and an OS 304;

FIG. 4 is a configuration diagram of an accounting server 103;

FIG. 5 is a pattern diagram showing a screen example displayed on a console terminal for user information setting 411;

FIG. 6 is a pattern diagram showing a data format of user information 401;

FIG. 7 is a pattern diagram showing a data format of an API reply 312;

FIG. 8 is a pattern diagram showing a data format of resource usage status 315;

FIG. 9 is a pattern diagram showing a data format of a return of information on resource used 319;

FIG. 10 is a pattern diagram showing a data format of server allocation information 410;

FIG. 11 is a pattern diagram showing a format of data to be stored in a resource usage status recording unit 418;

FIG. 12 is a pattern diagram showing a format of data to be stored in a resource usage history recording unit 424;

FIG. 13 is a flow chart showing processing steps in an accounting server when registering the user information 401 with the accounting server 103;

FIG. 14 is a flow chart showing steps in which the accounting server 103 acquires and collects server resource information used in the server, and then bills for the information;

FIG. 15 is a pattern diagram showing a configuration of a server application 1101, and a communication interface between the application 1101, an OS 304b and an SVP 206b;

FIG. 16 is a pattern diagram showing a data format of a transmission request for information on resource used 332b;

FIG. 17 is a pattern diagram showing a data format of a return of information on resource used 319b;

FIG. 18 is a pattern diagram showing a data format of a return of information on resource used 319c;

FIG. 19 is a pattern diagram showing a communication interface between an SVP 206c, and an OS 304c and an OS 304d in a server that is divided into a plurality of logical partitions; and

FIG. 20 is a pattern diagram showing a communication interface between the SVP 206c, and a hypervisor 2003, the OS 304c and the OS 304d in a server that is divided into a plurality of logical partitions.

### DETAILED DESCRIPTION OF THE PREFERRED EMBODIMENTS

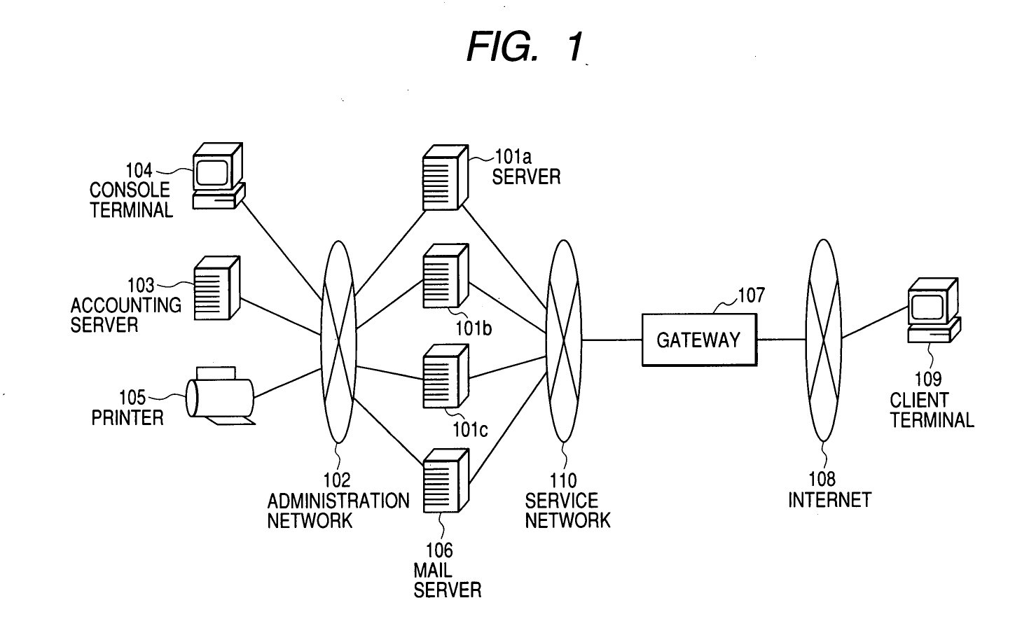

Hereinafter, embodiments of the present invention will be described with reference to FIGS. 1 to 20.

### First Embodiment

Hereinafter, a first embodiment of the present invention will be described with reference to FIGS. 1 to 14.

(I) Configuration of System for Resource Accounting on Computer Network

Hereinafter, a configuration of a system for resource accounting on a computer network according to the embodiments will be described with reference to FIGS. 1 to 4.

First, a configuration of the entire computer system of the embodiments will be described with reference to FIG. 1.

FIG. 1 is a configuration diagram of the entire computer system according to a first embodiment of the present invention.

Servers 101a, 101b and 101c are connected to both an administration network 102 and a service network 110. The servers 101a, 101b and 101c execute processing in accordance with a request from a user, and the user charged for server usage in accordance with the quantity of server resources such as CPU operating time and memory capacity that are used by those servers. The term “server” used here includes, for example, a Web server, a mail server, a file server and a database server.

To the administration network 102, an accounting server 103, a console terminal 104, a printer 105 and a mail server 106 are connected in addition to the servers 101a, 101b and 101c. The reason why the mail server 106 is stated here is that an E-mail will be used when a billing is executed.

The accounting server 103 acquires and accounts computing resources used by a user on a regular basis from servers, and then executes billing processing such as the issuance of an invoice.

The outlined steps of the accounting server 103 to acquire, account and bill the computing resource information used by the servers will be described later with reference to a flow chart.

A client terminal 109 is used by a user to make access to the server 101a, 101b or 101c, and at this time, a processing request by the user is transmitted via the Internet 108, a gateway 107 and a service network 110.

The console terminal 104 is used by a system administrator, prior to the use of the server 101a, 101b or 101c by a user, to register user information with the accounting server 103.

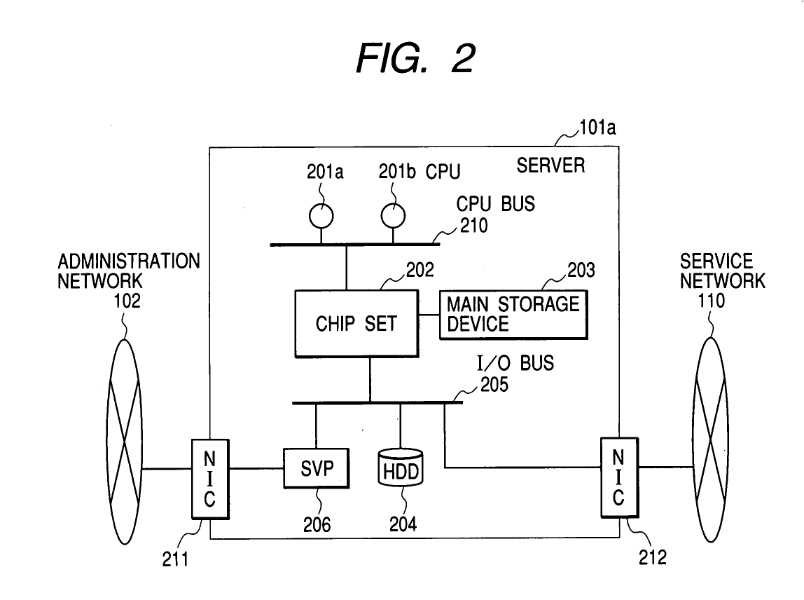

Next, an internal configuration of the server 101a will be described with reference to FIG. 2.

FIG. 2 is an internal configuration diagram of the server 101a. It should be noted that, since the servers 101b and 101c also have a similar configuration, only the server 101a will be described here.

The server 101a is provided with CPUs 201a and 101b as well as a chip set 202, and these devices are connected to each other through a CPU bus 210. In FIG. 2, it is depicted that the server 101a is provided with two CPUs, but not limited to, and the adequate number of CPUs may be mounted according to the requirement for system performance.

To the chip set 202, a main storage device 203 and an I/O bus 205 are connected in addition to the CPU bus 210. Accessing the main storage device 203 is made via the chipset 202 from the CPUs 201a or 201a.

To the I/O bus 205, an SVP (Service Processor) 206 which is a control device arranged independent of a CPU, an HDD 204 and an NIC (Network Interface Card) 212 in addition to the chip set 202. The term “independent of a CPU” implies that the SVP 206 is capable of making processing independent of the CPU and can execute controlling without being affected by the CPU operations. It should be noted that the purpose of arranging a CPU and an SVP independent of the CPU in the server is, for prior arts in general, to monitor the hardware environment of a server including a CPU in many cases.

The SVP 206 can access the main storage device 203 via the chip set 202. Accessing the HDD 204 is possible either from the CPU 201a or 201b. The NIC 212 is connected to the service network 110, and an OS or an application program that runs on a CPU executes communication via the NIC 212.

The I/O bus 205 is a bus which, for example, executes communication with peripheral circuits including a CPI bus.

To the SVP 206, an NIC 211 and the I/O bus 205 are connected. The NIC 211 is also connected to the administration network 102, and thus the SVP 206 can execute communication with the accounting server 103 via the NIC 311 and the administration network 102.

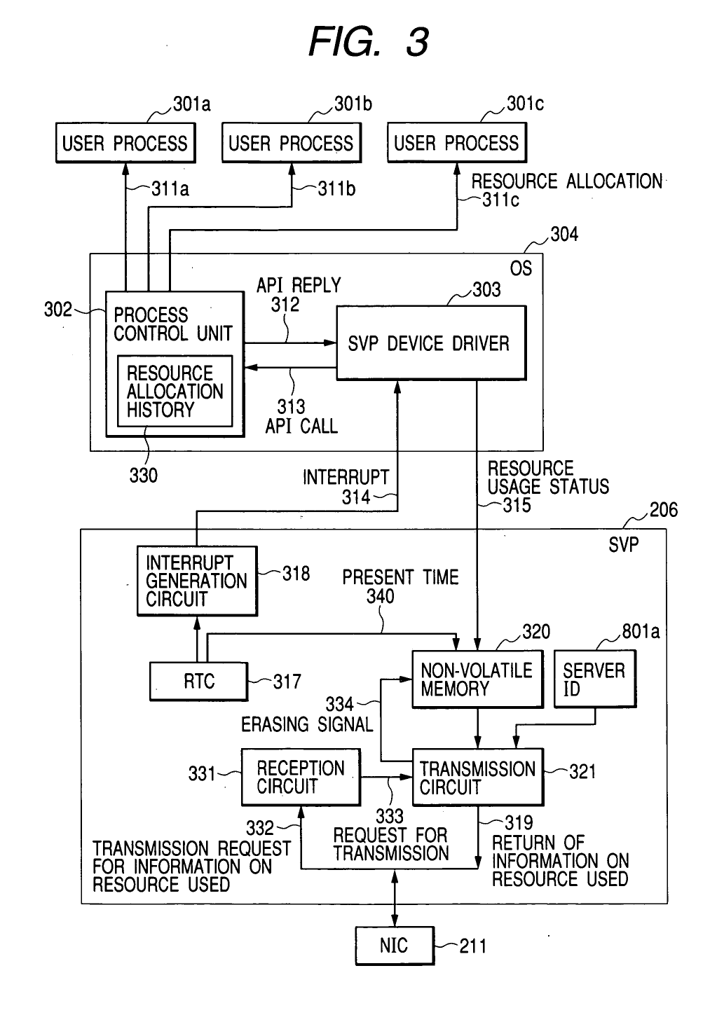

Next, a configuration and operations of the SVP 206 will be described with reference to FIG. 3.

FIG. 3 is a diagram showing a configuration of an SVP 206 and communication interface between the SVP 206 and an OS 304.

The SVP 206 includes an RTC (Real Time Clock) 317 and an interrupt generation circuit 318. The RTC 317 periodically transmits commands to the interrupt generation circuit 318 in a time interval from tens of microseconds to tens of milliseconds. The interrupt generation circuit 318, when receiving the commands, generates an interrupt 314, and executes an interrupt to the CPU.

The OS 304 is provided with an SVP device driver 303 and a process control unit 302.

Thereafter, being triggered by an interrupt 314 from the SVP 206, the SVP device driver 303 executes communication to the process control unit 302 being triggered by an API (Application Interface) call 313.

Here, it has been arranged that the SVP device driver 303 is operated according to the interrupt 314, but not limited to such arrangement. Examples of methods for initiating operations of the SVP device driver 303 other than using the interrupt could conceivably include a method wherein an identifier to instruct the initiation of operations is written from the SVP 206 to a specified area of the main storage device 203, and the SVP device driver 303 polls the specified area to initiate operations when finding the identifier thus written, and a method wherein a register replacing the specified area stated above is arranged in the SVP 206, and the SVP device driver 303 polls the register to initiate the operations.

The process control unit 302 executes resource allocations 311a, 311b and 311c to user processes 301a, 301b and 301c, respectively, and allocates resources such as a CPU operating time as appropriate to each process. At the same time, the process control unit 302 records the amount of resources allocated to each process in a resource allocation history 330. The process control unit 302, being triggered by the API call 313 from the SVP device driver 303, reads out the resource allocation history 330 and returns an API reply 312 to the SVP device driver 303. The API reply 312 is a reply which returns resource information to the API reply 313. The API replay 312 will be described later.

After having returned the API reply 312, the process control unit 303 erases the resource allocation history 330.

Upon receiving the API replay 312, the SVP device driver 303 collects the API replies 312, and notifies the SVP 206 of a resource usage status 315. The SVP 206 pairs the resource usage status 315 with present time 340 and re-records the pair in a non-volatile memory 320. The resource usage status 315 is a data of resource status usage assembled on a user basis.

For the above-stated arrangement, an example of a method of allowing the SVP device driver 303 to notify the SVP 206 of the resource usage status 315 could conceivably include a method wherein the resource usage status 315 is written in a specified area of the main storage device 203, and the SVP 206 polls the specified area to detect the writing.

Thereafter, a reception circuit 331 receives, via the NIC 211, a request for information on resource used 332 that is issued by the accounting server 103. The reception circuit 331 issues a transmission request 333 to a transmission circuit 321. The transmission circuit 321 pairs information on resource usage status stored in the non-volatile memory 320 with a server ID 801a to create a return of information on resource used 319, and transmits the return to the accounting server 103 via the NIC 211. The return of information on resource used 319 will be described in detail later.

Then, the transmission circuit 321 confirms the transmission completion of the return of information on resource used 319, asserts an erasing signal 334, and erases information on the resource usage status stored in the non-volatile memory 320.

With the above-stated processing, it is possible for a server to acquire information on resources used by a user in detail. Further, the information can be used not only for billing to a user that will be described later, but also for performance evaluation of a server system as well as an optimization index.

Next, a configuration and operations of the accounting server 103 will be described.

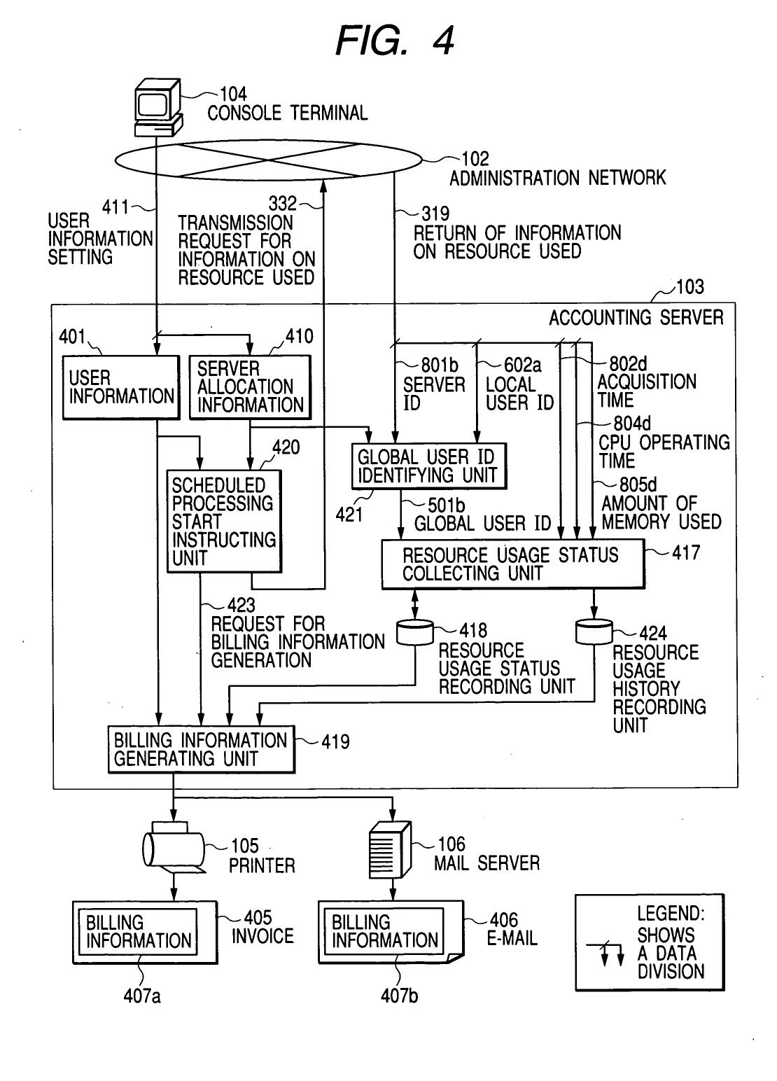

FIG. 4 is a configuration diagram of an accounting server 103.

An administrator performs processing for a user information setting 411, that is, operates a user registration window (to be described later) at the console terminal 104 to perform setting of server allocation information 410.

User information 401 is detailed information regarding a user. Further, the server allocation information 410 shows a relationship between users and servers and retains information regarding to which user the servers 101a, 101b and 101c are allocated. Details of the user information 401 and the server allocation information 410 will be described later.

Processing for the user information setting 411 will also be described in detail with reference to a flow chart.

Further, the accounting server 103 has a scheduled processing start instructing unit 420. The scheduled processing start instructing unit 420 enables billing to initiate at a given time every day, and the unit 420, for example, transmits the request for information on resource used 332 to the administration network 102 at 00 hour 00 minute every day. At this time, the request for information on resource used 332 may be transmitted only to a server in which a server ID 801d is registered in the server allocation information 410.

The servers 101a, 101b and 101c receive the request for information on resource used 332 from a scheduled processing start instructing unit 420 of the accounting server 103, and returns the return of information on resource used 319.

The accounting server 103 receives the return of information on resource used 319 from the servers 101a, 101b and 101c.

As described later, the return of information on resource used 319 includes fields of a server ID 801c, acquisition time 802, a local user ID 602d, CPU operating time 804 and an amount of used memory 805, and, among the fields, a server ID 801b and a local user ID 602a are entered to a global user ID identifying unit 421, while acquisition time 802d, CPU operating time 804d and an amount of used memory 805d are entered to a resource usage status collecting unit 417.

The resource usage status collecting unit 417 reads out data corresponding to a global user ID 501b received from a resource usage status recording unit 418, adds the data to the accumulated amount of CPU operating time which uses CPU operating time used 804, and adds the data obtained by multiplying the CPU operating time used 804 with the amount of used memory 805 as a cumulative amount of used memory, thus updating the resource usage status recording unit 418. The accounting server 103 determines the amount to be billed to a user based on cumulative CPU operating time 1002 and cumulative amount of used memory 1003.

The global user ID identifying unit 421 identifies global user ID identifying unit that corresponds to the server ID 801b and the global user ID 501b received, by referring to the server allocation information 410.

Further, the resource usage status collecting unit 417 updates data of the resource usage status recording unit 418 and, at the same time, re-records the data to a resource usage history recording unit 424. Data to be retained in the resource usage status recording unit 418 and the resource usage history recording unit 424 will be described in detail later.

Further, the scheduled processing start instructing unit 420 issues a request for billing information generation once a month, for example, on the last date of the month, and a billing information generating unit 419, being triggered by the request for billing information generation 423, executes billing processing.

For the billing, the billing information generating unit 419 determines an amount to be billed to a user based on the respective information of the cumulative CPU operating time used that is recorded in the resource usage status recording unit 418 and the cumulative amount of used memory.

The billing information generating unit 419 writes the billing amount determined and the information recorded in the resource usage history recording unit 424 in billing information 407a and 407b. The billing information 407a and 407b are transferred to the printer 105 and the mail server 106 respectively. The printer 105 outputs the information on a paper as an invoice 405, while the mail server 106 electronically transmits the information to a user as an E-mail 406. With such arrangement, the administrator can bill a user based on the server resources used by the user.

(II) User Interface to be Provided by the System for Resource Accounting according to the Embodiment

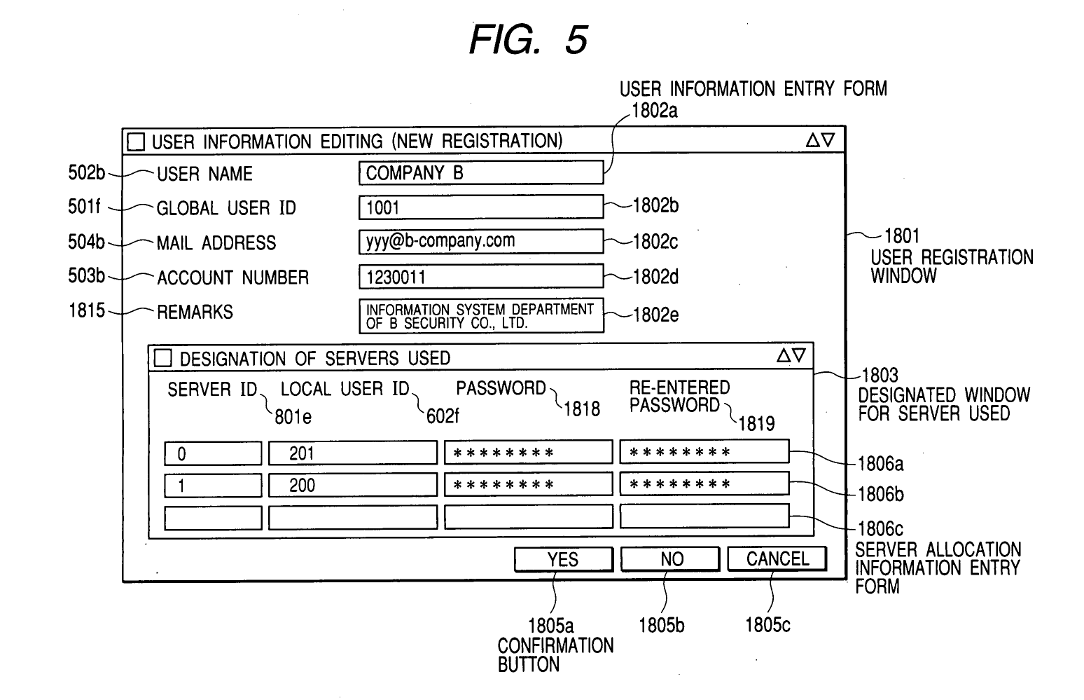

Next, a user interface for user registration to be provided by the system for resource accounting according to the embodiment with reference to FIG. 5.

FIG. 5 is a pattern diagram showing a screen example displayed on a console terminal for the user information setting 411.

When executing a user registration, a user registration window 1801 is displayed on a display unit such as a CRT of the console terminal 104. The user registration window 1801 is implemented as one of programs of the OS which has a graphical user interface (GUI) as represented by the Windows® of Microsoft.

Also, the window may be implemented as an HTML content generated by a server program such as a servlet in JAVA™ of Sun Microsystems and displayed by a WWW browser, or other realization means may be taken.

The administrator enters information of a user name 502b, a global user ID 501f, a mail address 504b, an account number 503b and remarks 1815 as user information in user information entry forms 1802a to 1802e. The user name 502b is a name of a user to be identified by the user or by the administrator.

The global user ID 501f is an identifier used by the accounting server to identify its user, and, with the embodiment, unique numbers are allocated within the system. More specifically, the global user ID 501f has an implication that it is a dedicated ID used for the system for resource accounting.

The mail address 504b is a mail address that is used by the accounting server 103 to transmit an invoice to the user of the address by means of an E-mail via the mail server 106 as depicted in FIG. 4.

The account number 503b is means for billing a usage charge of a server to the user of the account. In this connection, many similar methods such as a method that billing is executed by using a credit card and the credit card number is recorded in the field concerned would be considered for billing means in addition to the bank account.

The remarks 1815 is used for convenience of the administrator to record information regarding users who do not fall in the above-stated item.

In the example shown in FIG. 5, following strings are entered in respective fields: “Company B” for the user name 502b; “1001” for the global user ID 501f, “yyy@b-company.com” for the mail address 504b; “1230011” for the account number 503b; and “Information System Department of B Security Co., Ltd.” for the remarks 1815. Incidentally, it is assumed that the user has contracted an agreement to use server resources as a corporate user.

A designated window for server used 1803 is a window that is used to designate a server used by the above-stated user. The administrator enters a server ID 801e which designates a server used by the user, a local user ID 602f to be used by the server, a password 1818 which correspond to the local user IDs 602f, and a re-entered password 1819 in server allocation information entry forms 1806a to 1806c. In this example, the user can designate up to three servers, but not limited to, to be used by the user.

The server ID 801e is an identifier used to uniquely identify a server within the system, and in the embodiment a unique number is allocated within the system. It should be noted that the server ID may be a unique string in the system, like a Fully Qualified Domain Name (FQDN) of the server concerned.

In addition, the server allocation information implies a relationship between a user and a server, as described in detail later.

The local user ID 602f is an identifier used to uniquely identify a user within the server that is designated by the server ID 801e. In the embodiment a unique number is allocated within the system. For the local user ID 602f, a user ID that is managed by the OS may be used, but, if the ID can be uniquely identified within the server, a different ID number may be allocated. Also, the ID may be a unique string such as a user name of the OS instead of a number.

The password 1818 is a password that is required to authenticate a user in a case where a login is made by the user to a server shown as the server ID 801e, or where a request for processing is made through a servlet, etc. For making a login to a server, the user enters a local user ID 1817 and the password 1818 in the login screen of an OS.

When a request for processing is made through a servlet, etc., the user enters the local user ID 1817 and the password 1818 on a WWW browser of the client terminal 109.

In this example, for all characters entered in the entry form for the password 1818 in a designated window for server used 1803, an asterisk mark is echoed back to prevent password hacking. At this time, to prevent a wrong entry of password, the administrator enters the same string as that entered for the password 1818 in the re-entered password 1819. If the password 1818 and the re-entered password 1819 do not coincide with each other, a re-entry will be prompted to the administrator while displaying so. In this example, the server ID “0” and the local user ID “201” are entered in the server allocation information entry form 1806a, and the server ID “1” and the local user ID “200” are entered in the server allocation information entry forms 1806b. After entering the information, the administrator presses either confirmation button 1805a, 1085b or 1805c through a GUI operation. When the confirmation button 1805a indicating “YES” is pressed, information entered in the user information entry forms 1802a to 1802e, and the server allocation information entry forms 1806a to 1806c is stored in the accounting server 103. In addition, information entered in either of the forms 1806a to 1806c is also stored in the server designated by the server ID 801e, as required. When the confirmation button 1805b indicating “NO” or the confirmation button 1806c indicating “CANCEL” is pressed, information entered will be cancelled, and the information will not be stored in the accounting server 103 either.

(III) Data Configuration Used in the System for Resource Accounting of the Embodiment

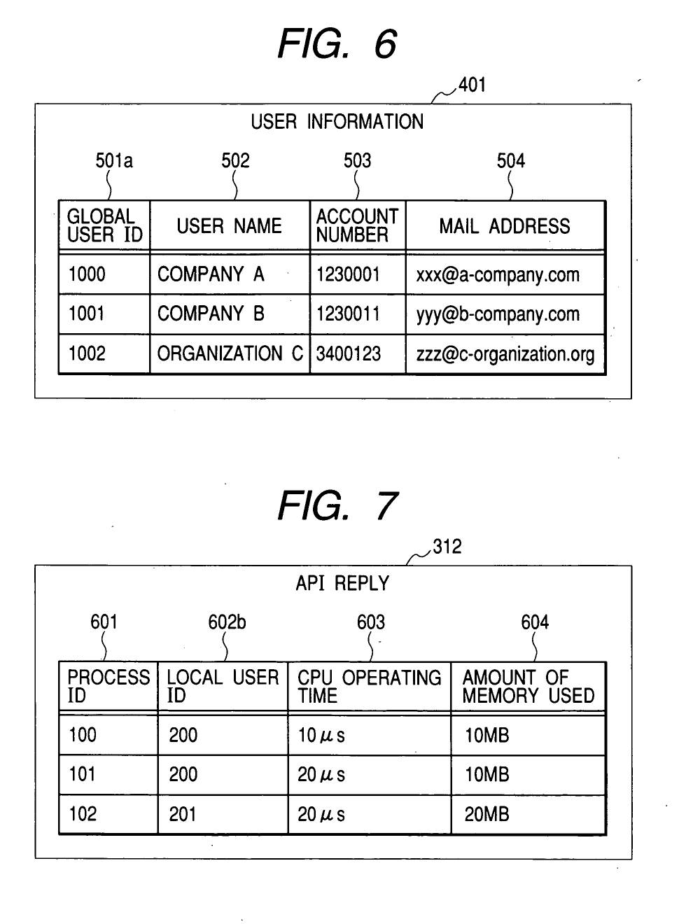

Next, a data configuration that is used in the system for resource accounting of the embodiment will be described with reference to FIGS. 6 to 12.

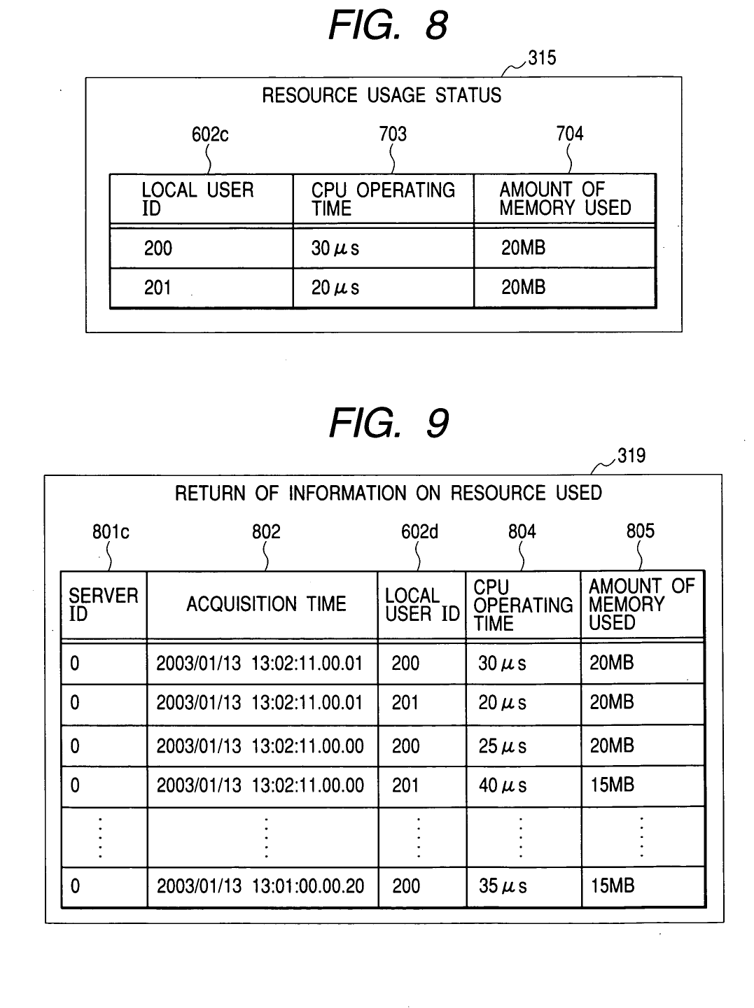

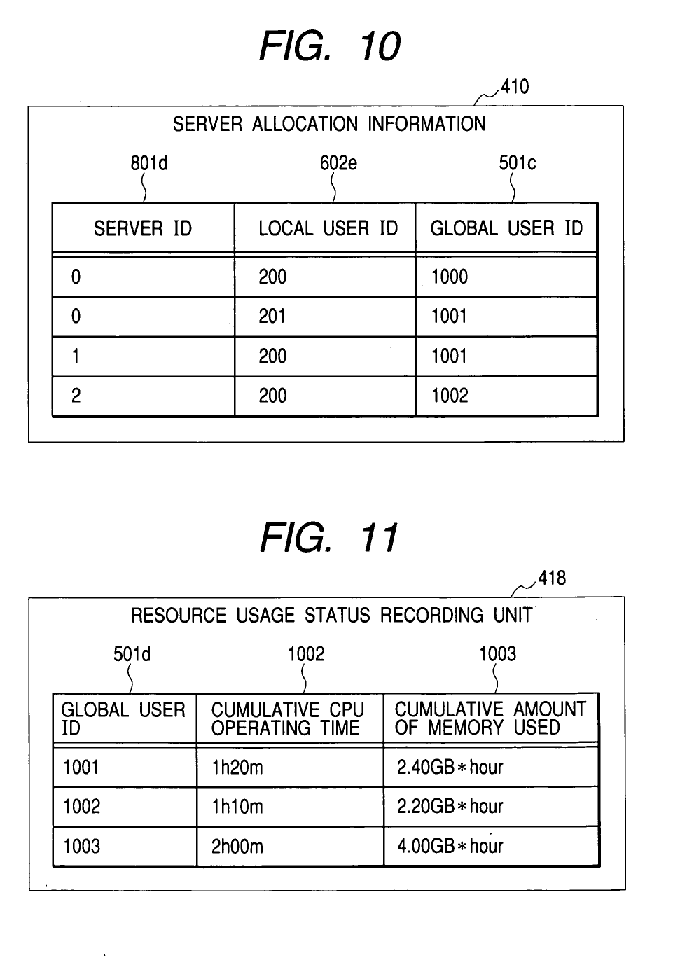

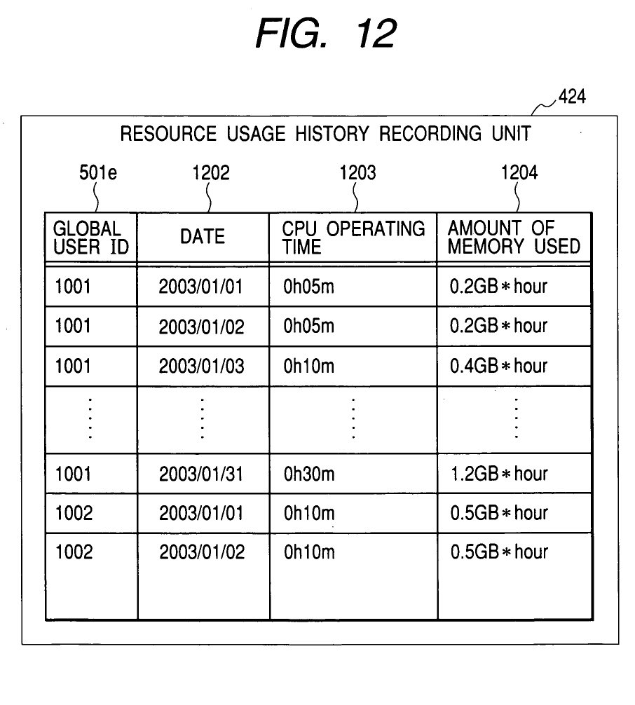

FIG. 6 is a pattern diagram showing a data format of the user information 401. FIG. 7 is a pattern diagram showing a data format of the API reply 312. FIG. 8 is a pattern diagram showing a data format of the resource usage status 315. FIG. 9 is a pattern diagram showing a data format of the return of information on resource used 319. FIG. 10 is a pattern diagram showing a data format of the server allocation information 410. FIG. 11 is a pattern diagram showing a format of data to be stored in the resource usage status recording unit 418. FIG. 12 is a pattern diagram showing a format of data to be stored in the resource usage history recording unit 424.

The user information 401 shown in FIG. 6 is information that is registered with the accounting server 103 from the console terminal 104 and contains fields of a global user ID 501a, a user name 502, an account number 503 and a mail address 504.

In the example, the first column which indicates a user identified with a number 1000 for a global user ID shows that the user name is “Company A”, the account number of the user is “1230001”, and the mail address of the user is “xxx@a-company.com”.

The API reply 312 shown in FIG. 7 is a reply to be returned by the process control unit 302 for the API call 313 of the SVP device driver in the OS 304. In addition, the API reply 312 contains fields of a core process ID 601 which is an identifier to uniquely identify a process in the OS 304, a local user ID 602b of a user who is the owner of the process, a CPU operating time 603 which was used by the process and an amount of used memory 604.

In the example, the first column indicates that the owner of a process identified as process ID number 100 is a user identified as local user ID number 200, the CPU operating time used by the process at the previous API call 313 and thereafter is 10 microseconds, and the amount of used memory is 10 MB. More specifically, by referring to the API reply 312, the SVP device driver 303 can grasp the amount of resources used in process ID unit.

The resource usage status 315 shown in FIG. 8 is information that is written by the SVP device driver 303 of the OS 304 in the non-volatile memory 320 of the SVP 206, and the resource usage status 315 contains fields of a core local user ID 602c, a CPU operating time 703 used by the user and an amount of used memory 704.

In the example, the first column indicates that the CPU operating time used by a process owned by a user identified as a local user ID number 200 after the previous interrupt 314 is 30 microseconds, and the amount of used memory is 20 MB. Note that the CPU operating time 703 and the amount of used memory 704 are the sums of values for the CPU operating time 603 and the amount of memory used 604, respectively, in the column or columns of the API reply 312 having the same local user ID 602b. More specifically, by referring to the resource usage status 315, the SVP 206 can grasp the amount of resources used in process ID unit.

The return of information on resource used 319 shown in FIG. 9 is information to be returned from the SVP 206 to the accounting server 103. In addition, and the return of information on resource used 319 contains fields of a server ID 801c, acquisition time 802, a local user ID 602d, CPU operating time 804 and an amount of used memory 805. In the field of the acquisition time 802, time when the above-stated resource usage status 315 is stored in the non-volatile memory 320 is recorded. An associating local user ID 602d, CPU operating time 804 and the amount of memory used 805 are recorded as the resource usage status data acquired in the field of the acquisition time 802.

In the example, the first column indicates that, in a server identified as a server ID number 0, 30 microseconds of CPU operating time and 20 MB of memory amount were used by a user identified as a local user ID number 200, at 13 hours 02 minutes 11.00.01 seconds on Jan. 13, 2003.

The server allocation information 410 shown in FIG. 10 is information to be registered with the accounting server 103 from the console terminal 104, and the information 410 retains fields of a server ID 801d, a local user ID 602e and a global user ID 501c.

In the example, the first column indicates that a user identified as a global user ID number 1000 uses a local user ID number 200 of a server identified as server ID number 0. The second column of the example indicates that a user identified as a global user ID number 1001 uses a local user ID 201 of the server ID number 0, and the third column indicates that a user identified as a similar global user ID number 1001 uses a local ID number 200.

By referring to the server allocation information 410, the accounting server 103 can identify the global user ID based on the server ID and the local user ID.

Data to be retained in the resource usage status recording unit 418 shown in FIG. 11 contains fields of a global user ID 501d, cumulative CPU operating time 1002 and cumulative amount of used memory 1003.

The data to be retained in resource usage status recording unit 418 is data to be updated by the resource usage status collecting unit 417 of the accounting server 103 as shown in FIG. 4.

In the example, the first column indicates that the cumulative CPU operating time used by a user identified as global user ID number 1001 in the present month is 1 hour and 20 minutes, and the cumulative amount of memory used is 2.4 GB*hour. Here, a unit of GB*hour is used as a unit for the cumulative amount of used memory. The GB*hour is a unit which will become 1 when an amount of 1 GB memory is used for one hour. However, the unit is not limited to the GB*hour, and other adequate units may be used, of course.

Data retained in the resource usage history recording unit 424 shown in FIG. 12 contains fields of a global user ID 501e, a date 1202, CPU operating time 1203 and an amount of used memory 1204.

Data retained in the resource usage history recording unit 424 is data to be written from the resource usage status collecting unit 417 of the accounting server 103 as shown in FIG. 4.

In the example, the first column indicates that a user identified as a global user ID number 1001 used the CPU operating time for five minutes and the memory of 0.2 GB*hour on Jan. 1, 2003.

By stating the information on an invoice, the accounting server 103 can define the basis of billing.

(IV) Steps of Method for Resource Accounting of the Embodiment

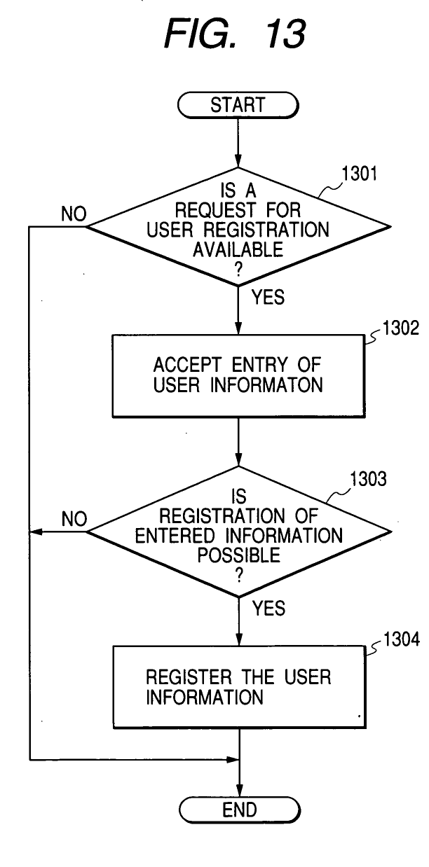

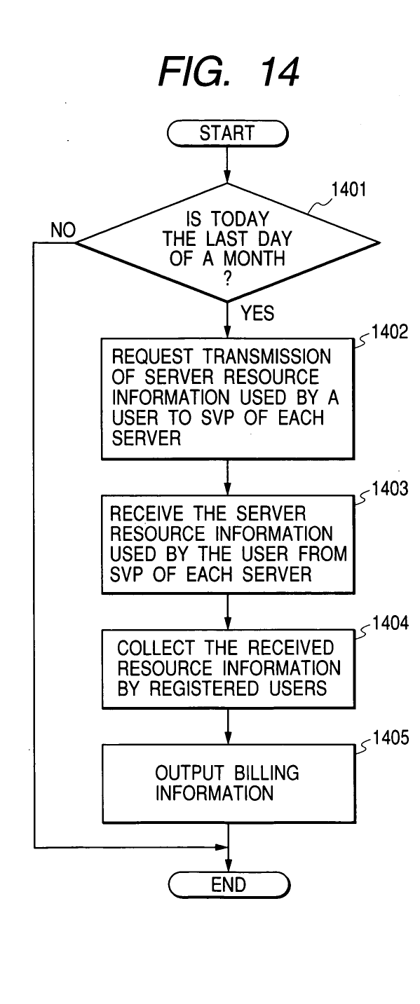

Next, steps of method for resource accounting of the embodiment will be described with reference to FIGS. 13 and 14.

FIG. 13 is a flow chart showing processing steps in an accounting server when registering the user information 401 with the accounting server 103.

The steps correspond to those of processing of the user information setting 411 shown in FIG. 4.

The accounting server 103 judges if a user registration is required (Step 1301).

When a user registration is not requested by the console terminal 104, the processing will be terminated. When the user registration is requested, an accept entry of user information is executed and an entry of necessary information is prompted (Step 1302).

After the necessary information is entered, an inquiry is made to the administrator as to whether the entered information can be registered or not (Step 1303).

When the inquiry reveals that registration is possible, the encountered information is stored in the accounting server (Step 1304). When the registration is not possible, the entered information is discarded and the processing is terminated.

Next, an outline of steps in which the accounting server 103 acquires and collects the server resource information used in the server will be described with reference to FIG. 14.

FIG. 14 is a flow chart showing steps in which the accounting server 103 acquires and collects server resource information used in the server, and then bills for the information.

In the example, the step is initiated at a fixed time every day, for example at 00 hours 00 minutes, and a judgment is made as to whether the present day is the last day of a month (Step 1401).

The judgment assures that the step is executed on the last day every month. Of course, it is possible to execute the step on an adequately determined date depending on the system or billing reasons. Then, a request is made to the SVP 206 of each server for transmission of server resource information used by a user (Step 1402).

The SVP 206 of each server has already acquired the server resource information used by the server and returns the server resource information used by the server in response to the request. Then, the accounting server 103 receives the server resource information used by each server that has been returned from the SVP 206 of each server (Step 1403). Thereafter, the server resource information received is collected for each registered user (Step 1404). Finally, billing information is output based on the server resource information thus collected (Step 1405).

### Second Embodiment

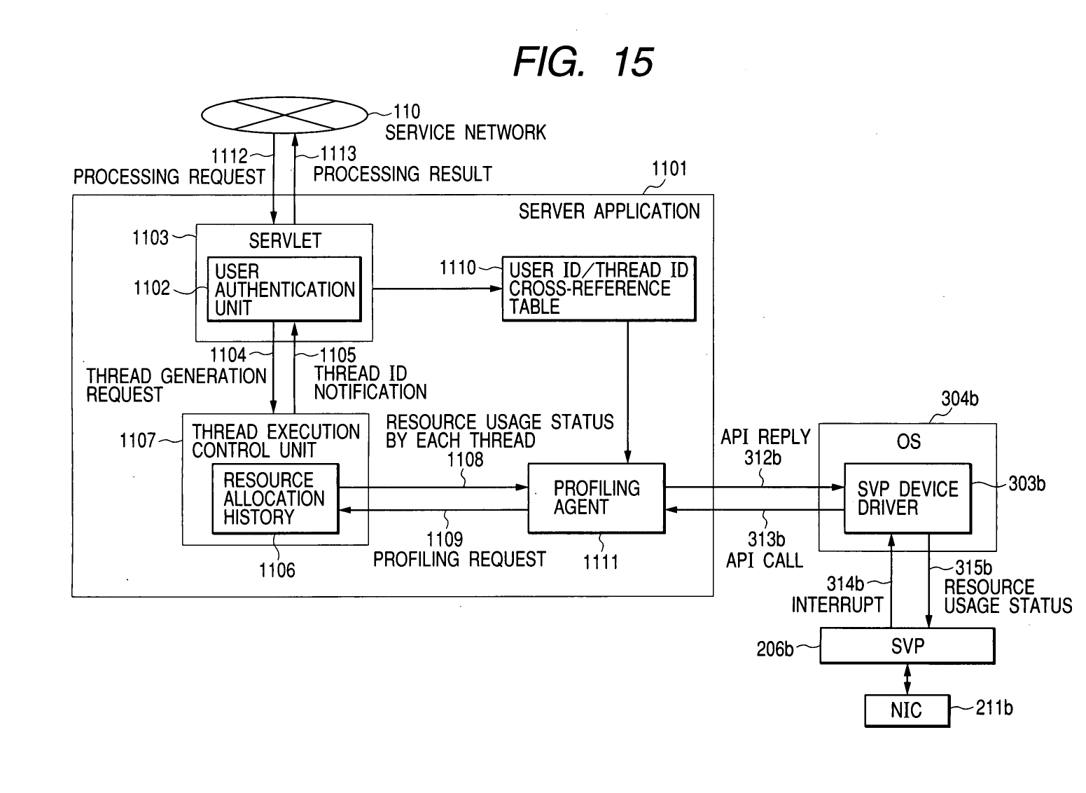

Next, a second embodiment according to the present invention will be described with reference to FIG. 15.

FIG. 15 is a pattern diagram showing a configuration of a server application 1101, and a communication interface between the application 1101, an OS 304b and an SVP 206b.

In the first embodiment, server resource information is acquired in a manner wherein the SVP 206 applies an interrupt to the SVP device driver 303 in the OS 304, and the SVP device driver 303 executes the API call 313 to the process control unit 302 in the OS 304.

In the second embodiment, the step in which an SVP applies an interrupt to an SVP device driver in the OS remains the same, but the different point is that acquisition of server resource information is executed by using a server application.

More specifically, in the embodiment, a server application represented by a servlet in JAVA (TM) of Sun Microsystems is initiated in the servers 101a, 101b and 101c.

As shown in FIG. 15, a server application 1101 includes a servlet 1103, a thread execution control unit 1107, a user ID/thread ID cross-reference table 1110 and a profiling agent 1111.

The servlet 1103 receives a processing request 1112 from a service network 110. A user authentication is executed in a user authentication unit 1102 when the servlet 1103 receives the processing request 1112. The processing request 1112 contains information on user IDs and passwords, and the user authentication unit 1102 implements an authentication by verifying such information with a pair of the local user ID 602f and the password 1818 that are entered through the user registration window 1801 referred to earlier in the first embodiment.

With the above-described processing, the servlet 1103 can identify the user requesting for the processing request 1112.

The servlet 1103, by using a thread generation request 1104, requests the thread execution control unit 1107 to generate a thread according to types of processing. In the example, the thread implies an execution unit within the server application 1101, and each thread is uniquely identified by an identifier called a thread ID. The thread execution control unit 1107, by using a thread ID notification 1105, notifies the servlet 1103 of the thread ID thus generated. Further, the thread execution control unit 1107 allocates server resources such as CPU operating time to each thread, and stores the allocation history of server resources in a resource allocation history 1106 in thread ID units. The servlet 1103 which received the thread ID notification 1105 stores a pair of a thread ID notified and a local user ID of a user who requested the processing in the user ID/thread ID cross-reference table 1110.

The SVP 206b periodically issues an interrupt 314b as is the case with the first embodiment. An SVP device driver 303b which received the interrupt 314b executes an API call 313b to the profiling agent 1111.

The profiling agent 1111 issues a profiling request 1109 and receives a resource usage status by each thread 1108. The resource usage status by each thread 1108 contains allocation history information of resources in thread units recorded in the resource allocation history 1106, and the profiling agent 1111 executes re-accounting for each local user ID by referring to information in the user ID/thread ID cross-reference table 1110 and transmits an API reply 312b to the OS 304b. The OS 304b notifies the SVP 206b of a resource usage status 315b in the manner described in FIG. 3 for the first embodiment to enable acquisition of server resource information.

With the above-described arrangement, it is now possible to bill a user based on server resources used by the user even in a case where the server application is initiated in the servers 101a, 101b and 101c.

### Third Embodiment

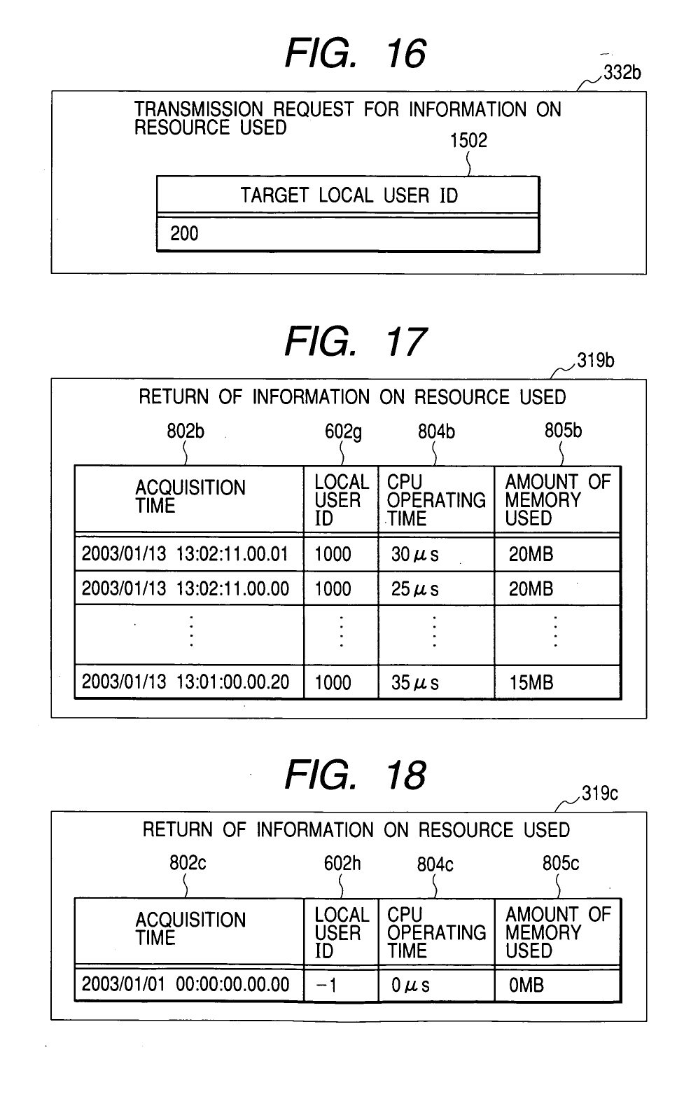

Next, a third embodiment will be described with reference to FIGS. 16 to 18.

FIG. 16 is a pattern diagram showing a data format of a transmission request for information on resource used 332b. FIG. 17 is a pattern diagram showing a data format of a return of information on resource used 319b. FIG. 18 is a pattern diagram showing a data format of a return of information on resource used 319c.

In the first embodiment, the request for information on resource used 332 that is made from the accounting server 103 to each server is not targeted for a specified user, but the request is intended to require resource information used by all users of the server. On the other hand, with the second embodiment, the request is intended to require resource information used by designating a specified user in the accounting server 103.

More specifically, the embodiment refers to an example wherein a transmission request for information on resource used 332 is broadcasted from the accounting server 103 to the administration network 102 to acquire only server resource information used by a specified user.

In the embodiment, it is assumed that a local user ID is used commonly for the servers 101a, 101b and 101c.

The accounting server 103, when requesting the SVP 206 of each server to transmit server resource information used by a user, broadcasts the transmission request for information on resource used 332b shown in FIG. 16 to the administration network 102.

The transmission request for information on resource used 332b contains a target local user ID 1502, and resource information used to be acquired is designated by such ID. In the example, it is requested that each SVP should transmit only server resource information used by a user whose local user ID is “200.”

The SVP 206, when it retains server resource information used by the user designated by the target local user ID, returns a return of information on resource used 319b shown in FIG. 17. While, when the SVP 206 does not retain the information, it returns a return of information on resource used 319c shown in FIG. 18.

The return of information on resource used 319b contains fields of acquisition time 802b, a local user ID 602g, CPU operating time 804b and an amount of used memory 805b. It should be noted that, with the embodiment, since it is assumed that a local user ID is commonly used among the servers 101a, 101b and 101c, the return of information on resource used 319b, unlike the resource information used 319, does not contain information on server IDs.

In the return of information on resource used 319c, the data format is the same as that of the return of information on resource used 319b, but for the purpose of showing that the SVP 206 does not have server resource information used by a user to whom the transmission request for information on resource used 332b is made, a special ID “−1” is designated in the filed of a local user ID 602h.

An accounting server that received the return of information on resource used 319c recognizes that “−1” has been designated to the local user ID 602h and discards the return information.

The accounting server 103 counts the number of receptions of the resource information used 319b and the resource information used 319c, recognizes that returns are available from SVPs 206 of all servers, and completes processing, by the processing 1404, of accounting for each user to whom received resource information is registered.

With the above-described arrangement, it is now possible to bill a user based on server resources used by the user.

### Fourth Embodiment

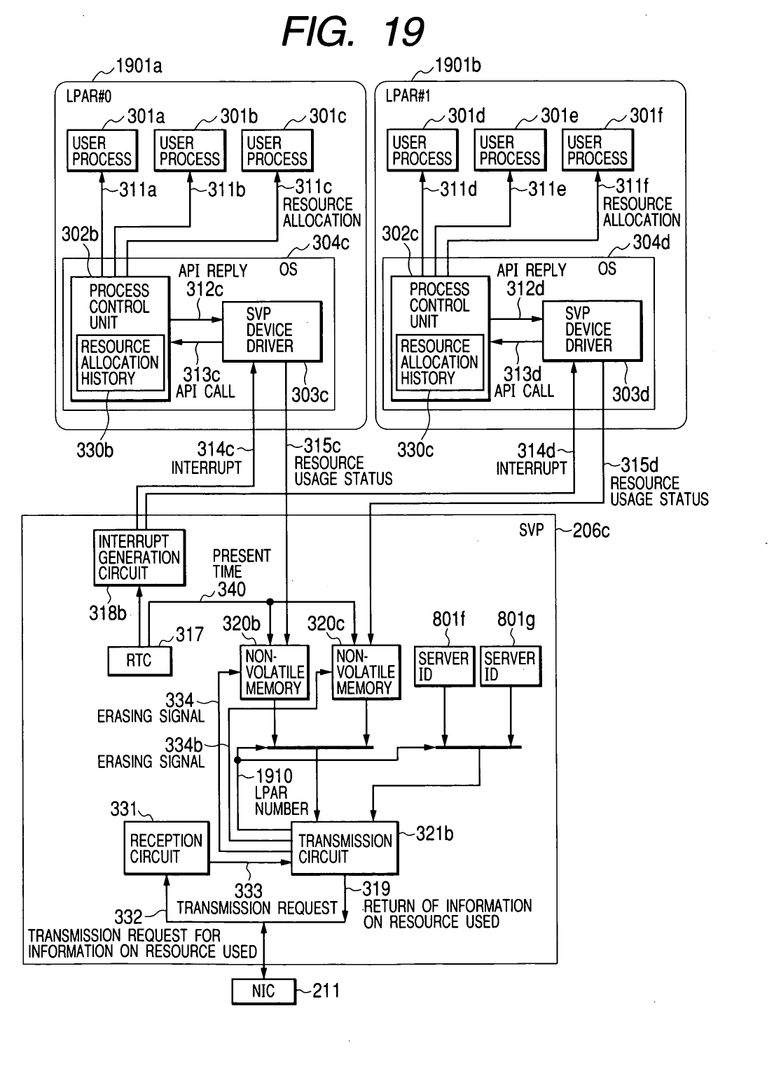

Next, a fourth embodiment will be described with reference to FIG. 19.

FIG. 19 is a pattern diagram showing a communication interface between an SVP 206c, an OS 304c and an OS 304d in a server that is divided into a plurality of logical partitions.

The fourth embodiment, unlike the first embodiment, shows an example wherein resource information used is acquired in a server that is divided into a plurality of logical partitions (hereinafter referred to as the “LPAR”).

In a server that is divided into a plurality of LPARs, part of server resources are allocated to individual LPARs, and an OS and a plurality of pieces of application software will be operated in each LPAR. In an example shown in FIG. 19, a server is divided into two LPARs, or more specifically, an LPAR #0 1901a and an LPAR #1 1901b. It should be noted that the number of LPARs is set to two due to space limitation in FIG. 19, but not limited thereto.

Since the LPAR #0 1901a and the LPAR#1 1901b are of a similar configuration, the LPAR #0 1901a will be described hereunder. In the LPAR #0 1901a, an OS 304c and user the processes 301a to 301c which correspond to application software are in operation. As is the case with the first embodiment, the SVP device driver 303c receives an interrupt 314c and returns resource usage status 315c.

The SVP 206c is an SVP that is used in the server concerned. Unlike the first embodiment, an interrupt generation circuit 318b has two interrupts 314c and 314d. The interrupt 314c corresponds to the LPAR #0 1901a, while the interrupt 314d corresponds to the LPAR #1 1901b, and the LPARs initiate the SVP device driver 303c and SVP device driver 303d respectively.

As is the case with the first embodiment, the RTC 317 periodically transmits commands to the interrupt generation circuit 318b in a time interval from tens of microseconds to tens of milliseconds. The interrupt generation circuit 318b generates both the interrupt 314c and the interrupt 314d and executes an interrupt to the CPU at the time of receiving a command.

The SVP device driver 303c returns the resource usage status 315c, and the status 315c is stored in the non-volatile memory 320b together with the present time 340. In addition, the SVP device driver 303d returns the resource usage status 315d, and the status 315d is stored in the non-volatile memory 320c together with the present time 340.

As is the case with the first embodiment, the reception circuit 331 receives, via the NIC 211, a request for information on resource used 332 that is issued by the accounting server 103, and issues the transmission request 333. A transmission circuit 321b, first of all, sets an LPAR number 1910 to “0”, chooses the non-volatile memory 320b and a server ID 801f that associate with the LPAR #0 1901a, and transmits a return of information on resource used 319. After confirming the transmission completion of the return of information on resource used 319, the transmission circuit 321b asserts an erasing signal 334, and erases resource usage status information associating with the LPAR #0 1901a that is stored in the non-volatile memory 320b.

Secondly, the transmission circuit 321b sets an LPAR number 1910 to “1”, chooses the non-volatile memory 320c and a server ID 801g that associate with the LPAR #1 1901b, and transmits a return of information on resource used 319. After confirming the transmission completion of the return of information on resource used 319, the transmission circuit 321b asserts an erasing signal 334b, and erases resource usage status information associating with the LPAR #1 1901b that is stored in the non-volatile memory 320c.

With the above-described arrangement, it is now possible, in a server that is divided into a plurality of LPARs, to acquire resource information used.

### Fifth Embodiment

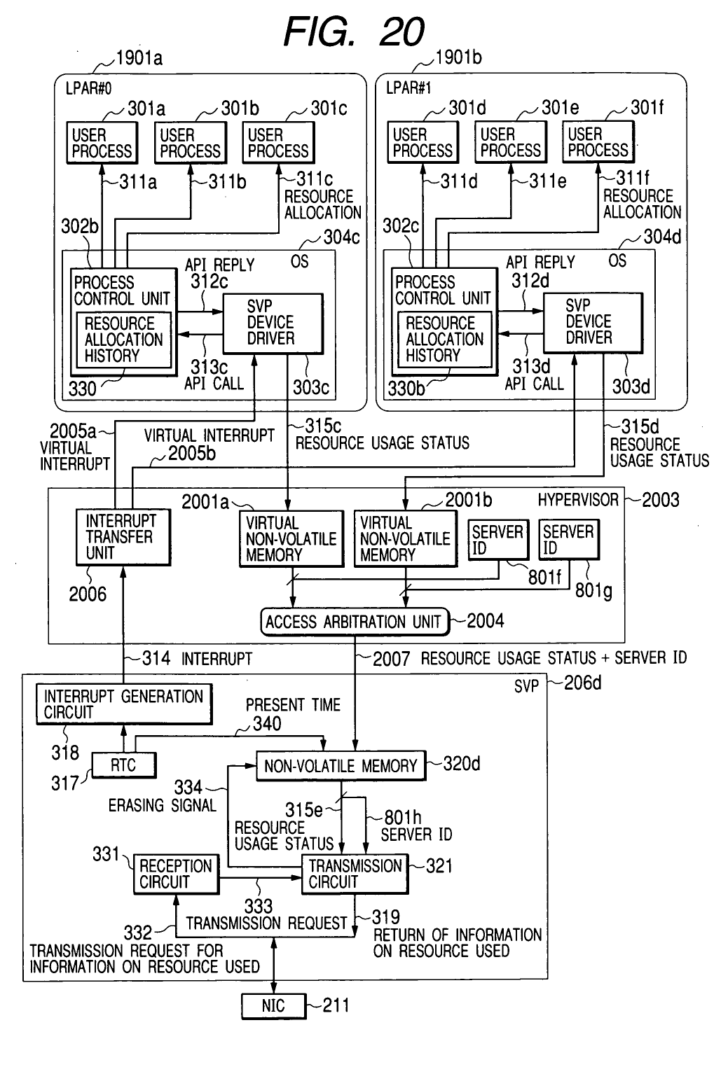

Next, a fifth embodiment will be described with reference to FIG. 20.

FIG. 20 is a pattern diagram showing a communication interface between the SVP 206d, and a hypervisor 2003, the OS 304c and the OS 304d in a server that is divided into a plurality of logical partitions.

Unlike the fourth embodiment, the fifth embodiment shows that an SVP 206d acquires resource information used of a server that is divided into a plurality of LPARs via the only one interrupt 314.

A hypervisor 2003 is a component to control allocation of a server resource to each LPAR, and the hypervisor 2003 is implemented as firmware. The SVP 206d and the hypervisor 2003 access each other via the interrupt 314 and resource usage status+server ID 2007. The hypervisor 2003 and the LPAR #0 1901a access each other via a virtual interrupt 2005a and the resource usage status 315c. In addition, the hypervisor 2003 and the LPAR #1 1901b access each other via a virtual interrupt 2005b and the resource usage status 315d.

In the embodiment, when the interrupt 314 is generated, an interrupt transfer unit 2006 in the hypervisor 2003 is initiated. The interrupt transfer unit 2006, upon receiving the interrupt 314, generates virtual interrupts 2005a and 2005b, and the interrupts initiate the SVP device drivers 303c and 303d respectively. The processing is realized by steps wherein the hypervisor refers to an external interrupting vector table owned by the OS 304c and the OS 304d to initiate an interrupt handler associating with the interrupt 314.

The SVP device driver 303c or 303d which received the virtual interrupt 2005a or 2005b return the resource usage status 315c or 315d respectively. The resource usage status 315c and 315d are stored in a virtual non-volatile memory 2001a and 2001b, respectively. The virtual non-volatile memory 2001a and 2001b are secured in a memory area arranged in the hypervisor.

An access arbitration unit 2004 pairs resource usage status stored in the virtual non-volatile memories 2001a and 2001b with the server IDs 801f and 801g, respectively, and transmits the resource usage status+server ID 2007 to the SVP 206d.

The SVP 206d which received the resource usage status+server ID 2007 pairs the present time 340 with the resource usage status+server ID 2007, and stores the pair in a non-volatile memory 320d.

The transmission circuit 321, when receiving a transmission request 333, reads out resource usage status 315e and a server ID 801h from the non-volatile memory 320d, and transmits the return of information on resource used 319. After confirming the transmission completion of the return of information on resource used 319, the transmission circuit 321 asserts the erasing signal 334, and erases resource usage status information stored in the non-volatile memory 320d.

With the above-described arrangement, it is now possible, in a server that is divided into a plurality of LPARs, to acquire resource information used via an only one interrupt.

[Effects of the Invention Best Understood From the Embodiments]

According to the present invention, it is possible to provide a method for accurate acquisition of resources and resource accounting on computer network that can be introduced without modifying architectures of existing OS's or CPUs even if a server has a large load.

1. A method for resource accounting on a computer network which collects resources used by a server of a computer system, wherein the computer system has an accounting server to collect server resources used by said server, said server and said accounting server are connected to each other over a network, and said server includes a CPU to initiate an OS or application software and a control unit to perform processing independent of said CPU,
said method comprising the steps of:
registering information on a user who uses said server;
allowing said registered user to use a resource of the server by initiating an OS or application software;
allowing said control unit to communicate with the OS or said application software that is operating on said CPU;
allowing said control unit to acquire the information on the user who used said server resource and resource information used including an amount of server resource used by the user through said communication;
allowing said control unit to transmit said acquired resource information used to said accounting server; and
allowing said accounting server to receive said resource information used and account the information on a user basis.

2. A method for resource accounting on a computer network according to claim 1, wherein,
said step of registering information on a user includes processing to set a global user ID to uniquely identify the user in the computer system, designate a server to be used by the user in the computer system according to a unique server ID, and set a local user ID to uniquely identify the user in the computer system;
said step of allowing said control unit to transmit said resource information used to said accounting server includes processing in which the local user ID associating with the user and the server ID associating with the server are transmitted as information to uniquely identify said user; and
said step of allowing said accounting server to receive said resource information used and account the information on a user basis includes processing to identify said global user ID associating with the user based on said local user ID and said server ID received, and account the amount of said server resource used on the identified global user ID basis.

3. A method for resource accounting on a computer network according to claim 2, wherein a user ID that is managed by the OS operating on said server is used as said local user ID.

4. A method for resource accounting on a computer network according to claim 2, wherein said OS or said application software authenticates said user, initiates execution of a thread based on a request by the user, acquires server resource information used by each of the thread, and transmits the server resource information acquired to said control unit on the local user ID basis.

5. A method for resource accounting on a computer network according to claim 1, further comprising the step of allowing said accounting server to request said control unit to transmit said resource information used thereto.

6. A method for resource accounting on a computer network according to claim 5, wherein
the step of allowing said accounting server to request said control unit to transmit said resource information used thereto includes processing of adding information to designate a user from whom said resource information used is to be acquired to a transmission request of said resource information used and transmitting the transmission request to said network by means of a broadcast; and
the step of allowing said server to transmit said resource information used to said accounting server includes processing in which, if said server retains the resource information of the user from whom said resource information used is to be acquired, only the resource information used of the user is selectively transmitted, and if said server does not retain the resource information of the user from whom said resource information used is to be acquired, then information showing the server does not retain the resource information used of the user is transmitted.

7. A method for resource accounting on a computer network according to claim 1, wherein, in the step of registering information on a user who uses said server, a registration is made by utilizing a graphical user interface (GUI).

8. A system for resource accounting on a computer network which accounts resource used by a server of a computer system,
wherein the computer system has an accounting server to collect server resources used by said server, said server and said accounting server are connected to each other over a network, and said server includes a CPU to initiate an OS or application software and a control unit to perform processing independent of said CPU;
wherein said server includes means for registering a user who uses said server, and means for recording, on a user basis, an amount of server resource used by the registered user by initiating the OS or the application software;
wherein said control unit including means making communication with the OS or the application software operating on said CPU, and acquiring, through the communication, resource information used that includes user information of the user who used said server resource and an amount of server resource used by the user, and means for transmitting said acquired resource information used to said accounting server; and
wherein said accounting server including means for receiving said resource information used from said control unit and accounting the information on a user basis.

9. A system for resource accounting on a computer network according to claim 8, wherein, said OS or said application software comprises:
a user authentication unit which authenticate said user;
a thread execution initiation unit which initiates execution of a thread based on a request by the user;
acquiring means for acquiring server resource information used by each of the thread; and
transmission means for transmitting the acquired server resource information to said control unit.

10. A system for resource accounting on a computer network according to claim 8, wherein, when registering information on a user who uses said server, said accounting server executes the registration via said network.

11. A server having a capability of acquiring a resource used, comprising:
a CPU to initiate an OS or application software;
a control unit to perform processing independent of said CPU;
means for recording the amount of server resource used for initiating said OS or said application software on said user basis and acquiring said amount of server resource as resource information used which contains user information of a user who used said server resource and the amount of server resource used by the user;
wherein said control unit includes means for making communication with the OS or the application software that is operating on said CPU, and means for acquiring said resource information used through the communication.

12. A server having a capability of acquiring resource used according to claim 11,
wherein said control unit includes an interrupt circuit which executes an interrupt to said CPU as means for requesting acquisition of said resource information used, and a device driver which is initiated by said interrupt as means for acquiring said resource information used, said device driver acquiring said resource information used by calling an API provided by said OS.

13. A server having a capability of acquiring resource used according to claim 11,
wherein said control unit includes a register which is writable from the control unit and readable from said CPU, and means for writing an identifier to request the register to acquire resource information used in the register, as means for requesting acquisition of said resource information used; and
wherein said means for acquiring said resource information used includes detection means for allowing said OS or said application software to detect said identifier that has been written by polling said register, an API call unit which calls an API provided by said OS or said application software, and an acquisition unit which acquires said resource information used.

14. A server having a capability of acquiring resource used according to claim 11, further comprising a main storage device having a specified area that is writable from said control unit and readable from said CPU;
wherein said main control unit includes means for writing an identifier to request said specified area to acquire resource information used, as said means for requesting acquisition of said resource information used; and
wherein said OS or said application software detects said identifier that has been written by polling said specified area, calls an API provided by the OS or the application software, and acquires said resource information used, as means for acquiring said resource information used.

15. A server having a capability of acquiring resource used according to claim 11, wherein said control unit further has a storage device which is writable from said CPU, and means for detecting writing to the storage device, whereby said control unit is enabled to acquire said resource information used when said OS or said software application writes said resource information used in said storage device.

16. A server having a capability of acquiring resource used according to claim 11, further comprising a main storage device having a specified area which is writable from said CPU and readable from said control unit, whereby said control unit is enabled to acquire said resource information used when said OS or said software application writes said resource information used in said storage device.

17. A billing method for resource used in a server of a computer system, wherein said computer system has an accounting server which accounts server resources used in said server, said server and said accounting server are connected to each other via a network, and said server includes a CPU to initiate an OS or application software and a control unit which executes processing independent of said CPU, said server comprising steps of:
registering information on a user who uses said server;
allowing said registered user to use resource of said server by initiating the OS or the application software;
allowing said control unit to communicate with the OS or the application software running on said CPU;
allowing said control unit to acquire resource information used which contains user information of a user who used said server resource and an amount of server resource used by the user through said communication;
allowing said control unit to transmit said acquired resource information used to said accounting server;
allowing said accounting server to receive said resource information used and account the information on said user basis;
determining an amount to be billed based on said resource information used that is accounted on said user basis; and
billing said amount to the user.

18. The billing method for resource used in a server of a computer system according to claim 17, wherein said step of transmitting said resource information acquired by said control unit to said accounting server includes processing for transmitting information on time at which said user used resource of the server, and
said step of allowing the accounting server to execute billing of said amount to the user includes processing of transmitting a server resource usage history that is generated based on said time information used to the user.

19. A server which is divided into a plurality of logical partitions, wherein the server initiates one OS and 0 or 1 or more application software on each logical partition, said server comprising one or more CPUs and a control device which executes processing independent of said CPU;
said control unit comprising means for requesting the OS or application software running on part or all logical partitions to acquire resource information used containing user information of a user who used a server resource and an amount of server resource used by the user; and
said OS or said application software comprise means for replying resource information used in response to a request from said control unit.

20. A server which is divided into a plurality of logical partitions, wherein the server is initiates one OS and 0 or 1 or more application software on each logical partition, said server comprising one or more CPUs, a control device which executes processing independent of said CPU and a hypervisor which accepts a request from said control unit;
said control unit comprising means for requesting said hypervisor to acquire resource information used which contains user information of a user who used said server resource and an amount of server resource used by the user:
said hypervisor comprising means for transferring said request to the OS or application software running on part or all logical partitions in response to a request from said control unit; and
said OS or said application software comprises means for replying resource information used in response to said request.

21. A server according to claim 19, further comprising an interrupt circuit as means for requesting acquisition of said resource information used.

22. A server according to claim 20, further comprising an interrupt circuit as means for requesting acquisition of said resource information used.
